(19) United States
(12) Patent Application Publication
(10) Pub. No.: US 2002/0142761 A1
(43) Pub. Date: Oct. 3, 2002

(54) Handoff between digital wireless office system (DWOS) radio-infrastructure units using a conference call

(76) Inventors: Yngve Kenneth Wallstedt, Solna (SE); Olof Tomas Backstrom, Ekero (SE)

Correspondence Address: DAVID E. BENNETT, COATS & BENNETT, P.L.L.C., 1400 CRESCENT GREEN, SUITE 300, CARY, NC, 27511, US

(21) Appl. No.: 09/775,102

(22) Filed: Feb. 1, 2001

(51) Int. Cl. H04Q 7/20

(52) U.S. Cl. 455/416; 455/436; 455/520

(57) ABSTRACT

An apparatus performs an inter-radio-infrastructure handoff (“inter-RI handoff”) in a private mobile communication system when a mobile terminal roams from a first area served by a first radio-infrastructure (RI) to a second area served by a second RI unit. The system comprises a first RI unit connected to a first radiohead (RH), and a second RI unit connected to a second RH. An inter-RI handoff is performed using a conference call.

### BACKGROUND OF THE INVENTION

This invention relates to a method and apparatus for performing handoffs within a digital wireless office system (“DWOS”) having plural Radio-Infrastructure units (“RI units”). Specifically, the invention relates to a method and apparatus for performing a handoff between the RI units using a conference call.

A public mobile communication system such as a public land mobile network (“PLMN”) includes a mobile terminal (“MT”), such as a mobile cellular telephone, communicating with any one of a plurality of geographically spaced base stations. Broadly, each base station defines a cell, and each cell forms an integral part of a larger cellular network. The size of a cell largely depends on the power rating of the corresponding base station. The base stations communicate with a mobile switching center (MSC) by means of intercellular trunk lines. The mobile switching center determines which of the base stations and channels should process a call with the mobile terminal based on considerations such as signal strength between each available channel and the mobile terminal.

Demand has grown in the last few years for private mobile services that meet the particular needs of mobile subscribers roaming inside buildings such as an office building or laboratory facility. A DWOS is an example of an autonomous private communication system (“APCS”) that provides an autonomous extension to a private branch exchange (“PBX”). A PBX numbering plan can be used inside the DWOS. A mobile terminal belonging to a corporate subscriber to a DWOS can communicate with other mobile terminals located inside or outside the area covered by the DWOS. The DWOS usually provides support for call back, caller identification and other features normally expected by mobile subscribers of the PLMN.

The DWOS typically operates on the 850 MHz cellular and the 1900 MHz personal communication service (“PCS”) frequency bands. The DWOS may be compliant with the Time-Division Multiple Access/136 specification (the “TDMA/136 specification”). Consequently, a TDMA compliant mobile terminal can be used to communicate with the DWOS. The digital part of the ANSI-136 standard is particularly applicable to the DWOS. The ANSI-136 standard including the TDMA/136 specification is hereby incorporated by reference in its entirety. The ANSI-41 standard is used to support mobility between the DWOS and the public cellular system. The ANSI-41 standard is hereby incorporated by reference in its entirety.

A DWOS in one known form has a maximum user capacity of about 450 users. When this capacity is exceeded problems occur such as busy signals, failed calls or dropped calls. In order to avoid overloading the DWOS the number of authorized mobile terminal subscribers could be limited. Limiting the number of authorized subscribers might prevent overloading the DWOS but also risks creating a mixed population of corporate authorized and unauthorized subscribers. Consequently, unintended dissatisfaction could develop among unauthorized subscribers.

One-way around this problem is to utilize two DWOSs in place of a single DWOS. A handoff would be required when an authorized subscriber roams between the area served by the first DWOS and the area served by the second DWOS. From the viewpoint of the authorized subscriber, the handoff between two DWOSs should appear to be seamless.

However, there is currently no support or ANSI-standard for handling a direct handoff between two DWOSs.

### SUMMARY OF THE INVENTION

An apparatus performs an inter-radio-infrastructure handoff (“inter-RI handoff”) in a private mobile communication system when a mobile terminal roams from a first area served by a first radio-infrastructure (RI) to a second area served by a second RI unit. The DWOS comprises a first RI unit connected to a first radiohead (RH), and a second RI unit connected to a second RH. In one aspect of the invention an inter-RI handoff is performed by setting up a conference call between the first RH and the second RH. In another aspect of the invention, an inter-RI handoff is performed using a conference call between a first frequency and a second frequency on the second RH. In another aspect of the invention, an inter-RI handoff is performed using a conference call between the mobile terminal, a virtual mobile terminal and a third party phone such as a third party business phone.

### BRIEF DESCRIPTION OF THE DRAWINGS

The following is a brief description of the drawings that are presented for the purposes of illustrating the invention and not for purposes of limiting the same.

FIG. 1 is a generalized block diagram illustrating a mobile terminal communicating in both a public mobile communication system and a private mobile communication system;

FIG. 2 is a schematic block diagram illustrating an RI unit.

FIG. 3 is an interactive schematic that shows the interactive steps involved in performing a direct handoff between a first RI unit and a second RI, according to the invention.

### DETAILED DESCRIPTION OF THE INVENTION

While the invention will be described in connection with one or more embodiments, it should be understood that the invention is not limited to those embodiments. On the contrary, the invention includes all alternatives, modifications, and equivalents as may be included within the spirit and scope of the appended claims.

It should be understood that the term “mobile terminal”, as used in the context of the invention, applies to any device capable of communicating with an autonomous private communication system, such as a DWOS. Examples of such mobile terminals include a TDMA compliant cellular telephone. Other examples include any device that has been modified or designed to communicate with a DWOS including, but not limited to: a personal digital assistant (“PDA”) such as a web ready PDA, and a laptop computer with cellular connect capability. The term “mobile subscriber” applies to a user of a mobile terminal that is authorized to use a cellular telephone system such as a DWOS.

While the ANSI-136 standard is used as an exemplary embodiment in this application, the invention as described herein is applicable to all cellular standards where support for autonomous private communication systems is provided.

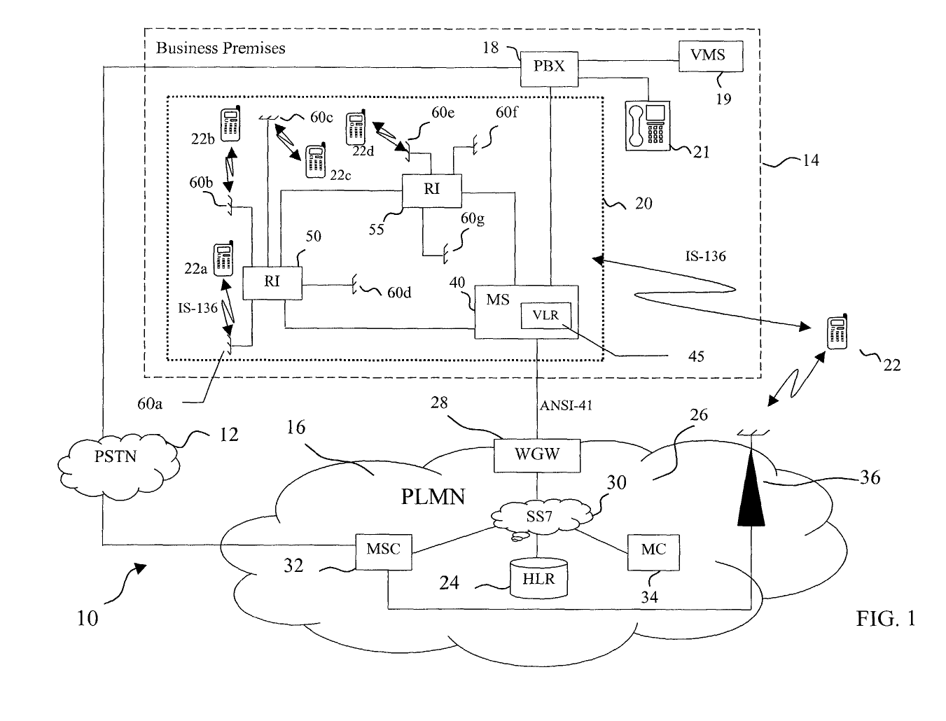

Referring initially to FIG. 1, a telephone communication system 10 is generally illustrated. The communication system 10 consists generally of the public switched telephone network (PTSN) 12 shown connected to a private business premises 14 and the public land mobile network (PLMN) 16. The business premises 14 include a private branch exchange (PBX) 18 and a DWOS 20. The PBX 18 communicates with the PSTN 12 in the conventional manner. The PBX 18 is also shown connected to a voice mail system (VMS) 19 and a fixed terminal 21 (represented by a desk phone).

The DWOS 20 is a fully digital mobile communication system that provides a mobile extension to the PBX 18. The DWOS 20 allows use of digital mobile terminals based on cellular or PCS standards within an office environment. The DWOS 20 is a private communication system that coexists with a public mobile communication system 26 in the PLMN 16 and uses the frequencies that are licensed to the operator of the particular network. The DWOS 20 automatically finds usable frequencies and operates on either one of the cellular bands (850 MHz) or one of the personal communication services (PCS) bands (1900 MHz). The DWOS 20 and its component parts are located within the area bounded by the dotted line.

A mobile terminal, referenced generically as 22, is adapted for communication both with the DWOS 20 and the public mobile communication system 26. Specific mobile terminals 22a, 22b, 22c, and 22d are illustrated in the DWOS 20. The mobile terminals such as 22a, 22b, 22c, and 22d must be defined in both the DWOS 20 and the public mobile communication system 26. The DWOS 20 interacts with a home location register (HLR) 24 using the ANSI-41 protocol. A wireless office system (WOS) SS7 gateway (WGW) 28 is used for inter-working between SS7 and TCP/IP if the HLR 24 does not use TCP/IP for communicating via an SS7 network 30. The term “TCP/IP” refers to the Transfer Communication Protocol and Internet Protocol. Another element of the PLMN 16 connected to the SS7 network is a conventional mobile switching center (MSC) 32. The MSC 32 is connected to the PSTN 12, and a message center 34. The MSC 32 is in turn connected to a base station 36 that communicates with the mobile terminal 22 in the conventional manner for public mobile communication systems.

The DWOS 20 includes a mobility server (MS) 40, a first Radio-Infrastructure unit 50 (i.e. RI unit 50), a second RI unit 55, radioheads 60a, 60b, 60c, 60d, 60e, 60f, 60g, and the mobile terminals 22a, 22b, 22c, and 22d. Each RI unit 50 and 55 is dedicated to serving a specific area in the DWOS 20, defined by the sum of the operating areas served by the radioheads 60 attached respectively attached to each RI unit.

A VLR 45 (visitor location register) is located within the mobility server 40. The VLR 45 keeps track of mobile terminals in two or more RI units and in the context of FIG. 1 the VLR 45 keeps track of authorized mobile terminals operating in the areas covered by the first and second RIs, 50 and 55 respectively. The mobility server 40 is separately operably connected to the first RI unit 50 and the second RI unit 55. The first RI unit 55 is operably connected to the radioheads 60a, 60b, 60c, and 60d. The second RI unit is operably connected to the radioheads 60e, 60f, and 60g. In addition, the first RI unit 50 is operably connected to the second RI unit 55.

The mobility server 40 provides a communication interface between the DWOS 20 and the outside world, such as the WAN/LAN (by means of e.g. FTP and HTTP), PLMN 16 (by means of ANSI-41, TCP, IP or Ethernet link), and the PBX 18. The terms “HTTP”, “FTP”, “WAN”, “LAN” refer to: Hyper Text Transfer Protocol, File Transfer Protocol, Wide Area Network and a Local Area Network, respectively.

The mobility server 40 preferably comprises a server, such as an NT Server, and a switchboard. The NT server can be a commercial NT server running the Open Telecommunication Platform (OTP). When present, the server handles connections between the DWOS 20 and the outside world (e.g. the WAN/LAN, PLMN 16 and the PSTN 12); in this respect the mobility server 40 is an example of an APCS-world communication interface unit.

The switchboard part of the mobility server 40 provides the switching element of the DWOS 20 and is used to help establish speech connections through the DWOS 20. The mobility server 40 also helps keep track of the mobile terminals 22 operating inside the DWOS 20. For example, the RI unit 50 monitors each mobile terminal 22 operating in its area and updates the mobility server 40 with this information via the ISDN connection.

The radioheads, referenced generically as 60, of the DWOS 20 are preferably placed indoors and cover a specific area of the DWOS 20. At least one antenna is integrated into each radiohead 60. The radioheads 60 provide overlapping coverage to ensure continuous coverage in the area served by the DWOS 20.

The radioheads 60 provide the radio links for the voice and control channels according to the ANSI-136 Rev. 0 air interface standard and assist in signal strength measurements. Although not shown, each radiohead 60 comprises a transceiver, a scanning receiver and control module, a radio-frequency (RF) transmitter section and an RF receiver section. The components of the radiohead could be integrated, e.g. the RF transmitter and receiver sections could be integrated. The radiohead 60 supports at least two carriers (i.e. for at least one DTC and at least one DCCH) and at least one scanning uplink receiver; DCCH=Digital Control Channel; DTC=Digital Traffic Channel. The radiohead 60 can be regarded as an example of a transceiver suitable for communicating mobile communication traffic within the confines of the DWOS 20.

Alternatively, the scanning receiver and control module, radio-frequency (RF) transmitter section and the RF receiver section or each radiohead could be integrated into the RI unit. Thus each radiohead could be a transceiver with the functions of the scanning receiver and control module, radio-frequency (RF) transmitter section and the RF receiver section, carried out by the RI unit.

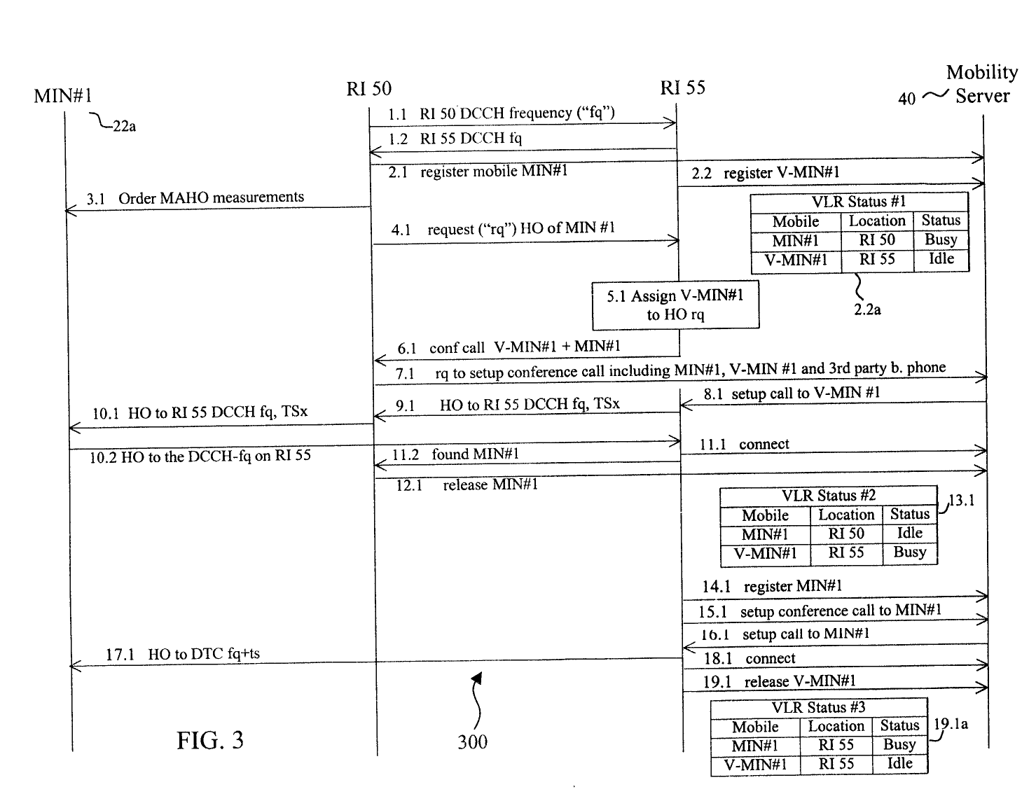

Each RI unit 50 and 55 is an example of a fixed communication interface unit located inside the DWOS 20. The term “fixed” simply refers to the stationary nature of the RI unit. The RI unit provides a higher-node function in that a pair of RI units provide handoff functionality somewhat akin to the MSC 32, FIG. 1. The MSC 32 coordinates the handoff of a radio call from one cell served by a first base station to a second cell served by a second base station to maintain call continuity. Specifically, the invention is directed to performing an inter-RI handoff such as a handoff from the first RI unit 50 to the second RI unit 55 by setting up a conference call between the RI units 50 and 55 (see FIG. 3 and accompanying explanation below).

A mobile terminal 22 located in the area served by the DWOS 20, such as the mobile terminal 22a, may be reached either through its PLMN telephone number or a DWOS user number. The general communication principles involving the mobile terminal 22a and the DWOS 20 and PLMN 16 are known and are not specifically described herein. The present invention relates particularly to conducting a handoff between the first RI unit 50 and the second RI unit 55 when a mobile terminal is engaged in a cellular radio call in a first area served by the first RI unit 50 and roams into a second area covered by the second RI unit 55. More specifically, the invention is directed to using a conference call to perform a call handoff between a mobile terminal 22 and a radiohead operably connected to the first RI unit 50 to a radiohead operably connected to the second RI unit 55.

In the illustrated embodiment of the invention, the connection between the first RI unit 50 and the second RI unit 55 is an Ethernet connection. The first RI unit 50 and the second RI unit 55 are connected to the mobility server 40 by means of an Integrated Service Digital Network (ISDN) connection. The connection between the mobility server 40 and the PBX 18 is supported by the primary rate interface “PRI” connection. The radioheads 60 connected to each RI unit communicate by a radio signal with the mobile terminals as depicted in FIG. 1.

The mobile terminal 22a can roam between the areas covered by the first RI unit 50 and the second RI unit 55. For purpose of illustration, the first and second RI units 50 and 55 provide mobile coverage for a first and second floor of an office building, respectively. For example, if the user of a mobile terminal 22a roamed into a room on the first floor covered by radiohead 60a, the mobile terminal 22a could make a cellular call via radiohead 60a. The mobile terminal 22a could roam into a room on the second floor covered by radiohead 60g and the signal strength would naturally decrease and increase with respect to radioheads 60a and 60g, respectively. At some point, the signal strength between the mobile terminal 22a and radiohead 60g would be preferred and lead to a handoff between the radioheads 60a and 60g resulting in an inter-RI handoff between the first and second RI units 50 and 55, respectively. In this illustration of the invention, the second RI unit 55 is the “target RI” since it is the target of the handoff; conversely the first RI unit 50 is regarded as the “source RI unit.”

The mobile terminals 22 are usually in one of several states, including: (1) switched off or in a powered down state; (2) switched on or in a powered up state, but not actively engaged in a call; and (3) switched on and engaged in a radio call. In the second state, the mobile terminal 22 would normally camp on the nearest RI unit (i.e. perform signal strength measurements with the radiohead operably connected to the nearest RI). It is preferable for efficient routing of calls that the mobility server 40 (and in particular the VLR 45) is kept informed about the location of each mobile terminal 22 camping or engaged in a call within the DWOS 20.

In an illustrative example of the invention, the mobile terminal 22a is powered up and camped on the first RI unit 50. The first RI unit 50 would communicate this information to the VLR 45 via the connection between the first RI unit 50 and the mobility server 40. In this way, if an incoming call for the mobile terminal 22a is received by the mobility server 40, then the call can be routed directly to the first RI, 50 on which the mobile terminal 22a (the target of the incoming call) is camped.

Table 1 illustrates the inter-RI handoffs that can take place within the DWOS 20. As the mobile subscriber roams around the DWOS 20 network the mobile terminal 22 performs signal strength measurements under Mobile Assisted Handoff (MAHO) to verify when an inter-RI handoff is required.

TABLE 1 (SEE FIG. 1)

| | Possible Inter-RI HOs | | Examples of RHs involved in |
|---|---|---|---|
| Scenario # | Source RI | Target RI | inter-RI HOs |
| 1 | RI unit 50 | RI unit 55 | 60c to 60f, 60d to 60g, 60d to 60e |
| 2 | RI unit 55 | RI unit 50 | 60e to 60c, 60e to 60d, 60g to 60d |

Abbreviations that apply to Table 1: HOs = handoffs; RHs = radioheads.

It should be understood that while the invention encompasses intra-RI handoffs, i.e. a handoff between two radioheads connected to the same RI, e.g. an intra-RI handoff between radioheads 60a and 60b that are both wired to the first RI unit 50, the invention is particularly directed to performing an inter-RI handoff, e.g. a handoff between a first radiohead connected to the first RI unit 50 and a second radiohead connected to the second RI unit 55.

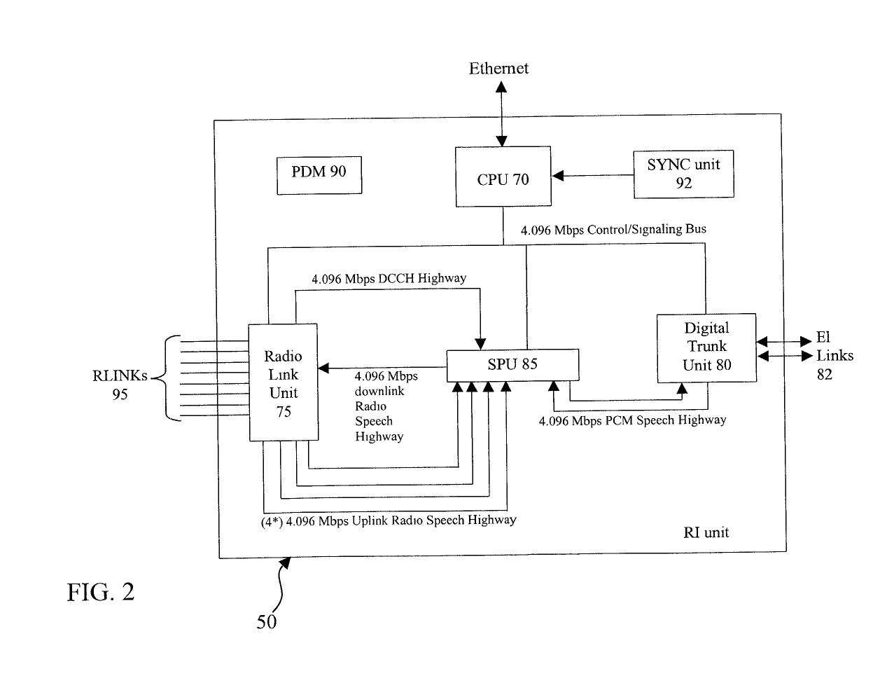

Referring to FIG. 2, a block diagram of the first RI unit 50 is shown for illustration purposes. The components of the first RI unit 50 include a central processor unit 70 (“CPU 70”), a radiolink unit 75 (“RLU 75”), a digital trunk unit 80 (“DTU 80”), a signal-processing unit 85 (“SPU 85”), a power distribution module 90 (“PDM 90”), and a SYNC unit 92. As will become clear below, the RI unit 50 supports multicasting of control DCCHs and radiohead selection.

The RLU 75 includes radiohead-links 95 (“RLINKS 95”) that interface with the radioheads 60, e.g. the RLINKS 95 in RI unit 50 interface with radioheads 60a, 60b, 60c and 60d. Though eight RLINK 95 interfaces are preferred, the number of RLINK interfaces 95 may vary. The RLU 75 is connected to the SPU 85 by an uplink radio speech highway connection, a downlink radio speech highway connection and a DCCH highway connection.

The DTU 80 interfaces with the mobility server 40 switchboard and the RI's own SPU 85. The digital trunk unit 80 includes two E1 interfaces 82 with 64 kbits/sec voice time slots, two control time slots, and two E1 framing time slots between the RI unit 50 and the mobility server 40. A pulse code modulation (“PCM”) speech highway connects the DTU 80 and the SPU 85.

The CPU 70 communicates with other RI unit CPUs via the Ethernet connection between each RI unit. Thus, the CPU in RI unit 50 communicates with the CPU in RI unit 55 via an Ethernet connection.

The SYNC unit 92 provides a stable timing reference for the first RI unit 50. A shielded twisted pair cable is preferred for transporting the reference time signal from the SYNC unit 92 to the CPU 70. The SYNC unit 92 is operably connected to the central processing unit 70. The CPU 70 is capable of implementing a call handoff using a conference call as discussed below.

A control/signaling bus connects the DTU 80, SPU 85, RLU 75, and the CPU 70.

It should be understood that several of the components described in the context of FIG. 2 may be performed in software and could be integrated. For example, the separate functions of the CPU 70 and the SYNC unit 92 could be integrated and carried out on a single integrated processor. Likewise, the SPU 85 could be integrated with the DTU 80 and RLU 75 to provide a single interface unit for handling radio traffic and line traffic, and further integrated with the CPU 70 and still further integrated with the SYNC unit 92.

The RI unit is an example of a communication controller with higher node functionality. In a public mobile communication system 16 (FIG. 1) the MSC 32 possesses higher node functionality wherein the MSC co-ordinates the handoff of mobile terminal calls between base stations in a public cellular system. In the present invention, the RI unit is provided with higher node functionality wherein the RI unit uses a conference call to perform a mobile terminal call handoff to another RI unit.

In one aspect of the invention, an inter-RI handoff is accomplished between two separate RI units by performing the steps described below. For purpose of illustration an authorized subscriber using mobile terminal 22c is assumed to be initially engaged in a radio call via the first radiohead 60c hard wired to the first RI unit 50. The mobile terminal 22c then roams into an area covered by a second radiohead 60e that is hard wired to the second RI unit 55. (The abbreviations used in steps (i) to (viii), below, include: DCCH=Digital Control Channel; DTC Digital Traffic Channel; MAHO=Mobile Assisted Handoff; MS=mobility server 40; RI unit Radio-Infrastructure unit; RH=radiohead; RHs=radioheads; MT=mobile terminal; and HO=handoff.) In this illustration of the invention, the inter-RI handoff is accomplished by performing steps (i) to (viii):

(i) establishing that the signal strength between the MT 22c and RH 60e is preferable over the signal strength between the MT 22c and RH 60c. The MAHO protocol is used for measuring the signal strength of a frequency, a DCCH-frequency on the target RI unit (in this illustration, this is the DCCH-frequency used by RH 60e, each RI unit communicates their currently used DCCH-frequencies with every other RI unit via the Ethernet link between the RI units 50 and 55);

(ii) setting up a conference call between the first RI unit 50 and the second RI unit 55 (i.e. involving RHs 60c and 60e, respectively);

(iii) handing off the MT 22c to the DCCH-frequency used by the RH 60e;

(iv) discontinuing the call between the MT 22c and the first RI unit 50 (i.e. RH 60c);

(v) registering the location of MT 22c on the second RI unit 55 and holding this information on the mobility server 40, wherein the second RI unit 55 instructs the mobility server 40 to register MT 22c on the second RI unit 55;

(vi) setting up a conference call between the DCCH-frequency currently used by RH 60e (hardwired to the second RI unit 55) and another frequency (a DTC-frequency, which will be used hereafter in this illustration) on RH 60e;

(vii) handing off the MT 22c from the DCCH-frequency on the second RI unit 55 (i.e. RH 60e) to the DTC-frequency on RH 60e; and

(viii) discontinuing the call on the DCCH-frequency on RH 60e while maintaining the call on the DTC-frequency on RH 60e, thus completing the inter-RI handoff between the first RI unit 50 and the second RI unit 55.

FIG. 3 is an interactive schematic 300 that shows the interactive steps that occur when a handoff is performed between the first RI unit 50 and the second RI unit 55, according to the invention. For purpose of illustration the architecture showed in FIG. 1 is assumed along with the abbreviations used above in steps (i) to (viii). The mobile terminal 22a is engaged in a call with another party using a business phone 21 (i.e. the fixed terminal 21).

The mobile terminal 22a is assigned a mobile identification number “MIN#1”. In addition, the VLR 45 assigns a MIN to a virtual mobile terminal “V-MIN#1”, wherein the virtual mobile terminal V-MIN#1 is a phantom or imaginary mobile terminal that is used to achieve the inter-RI handoff from the source RI unit 50 to the target RI unit 55. The VLR 45 keeps track of the real mobile terminal (i.e. MIN#1) and the virtual mobile terminal (i.e. V-MIN#1). The source and target RI units (50 and 55, respectively) exchange information over the Ethernet, the exchanged information includes the DCCH-frequency that each RI unit is using. The DCCH-frequency on RHs could be the same or different. MIN#1 performs MAHO measurements on neighboring RI units and their respective RHs. For purpose of illustration, MIN#1 will perform MAHO measurements on RHs 60a and 60g, wherein RH 60g is attached to RI unit 55, the target RI unit.

The interactive steps of FIG. 3 may be grouped: (a) establishing a handoff request (described in sections 1.1 to 3 below); (b) setting up a conference call as a vehicle to perform an inter-RI-handoff to the DCCH-frequency of the target RI unit 55 (4.1 to 13.1); and (c) performing an intra-RI handoff to restore VLR data and establish a call on a non-DCCH-frequency (14.1 to 19.1). Sections 1.1 to 19.1 (referencing FIG. 3) are:

Establishing A Handoff Request

1.1 The source RI unit 50 communicates its current DCCH-frequency via the Ethernet to the target RI unit 55;

1.2 The target RI unit 55 communicates its current DCCH-frequency via the Ethernet to the source RI unit 50;

2.1 RI unit 50 registers MIN#1 on the mobility server 40 (i.e. on the VLR 45);

2.2 RI unit 55 registers V-MIN#1 on VLR 45, see Table 2.2a;

3.1 RI unit 50 instructs mobile terminals 22 in radio contact with its RHs 60 to perform MAHO signal strength measurements on neighboring RI units (including RI unit 55);

Performing An Inter-RI-Handoff To The DCCH-Frequency Of The Target RI

4.1 RI unit 50 sends a message to RI unit 55 “requesting HO of mobile 1 (i.e. MIN#1) currently on this channel (frequency and time slot)”;

5.1 RI unit 55 assigns V-MIN#1 temporarily to the HO request;

6.1 RI unit 55 responds to the HO request of step 4.1 by setting up a conference call between MIN#1 and V-MIN#1;

7.1 Source RI unit 50 requests the mobility server 40 to connect a conference call including the MIN#1, the V-MIN#1 and the third party business phone 21;

8.1 A time slot in the DCCH-frequency on RI unit 55 is assigned to the conference call to V-MIN#1;

9.1 RI unit 55 sends a request to RI unit 50 instructing RI unit 50 to HO MIN#1 to the DCCH-frequency and time slot of step 8.1 (i.e. RI unit 50 HO MIN#1 to the DCCH-frequency on RI unit 55);

10.1 RI unit 50 responds to the request of step 9.1 by instructing MIN#1 to HO to the channel-frequency of step 9.1 (i.e. the DCCH-frequency being used by RI unit 55);

10.2 MIN#1 complies with the instruction and performs HO to the DCCH-frequency on RI unit 55;

11.1 When RI unit 55 detects MIN#1 on its DCCH-frequency, RI unit 55 through-connects a speech path;

11.2 RI unit 55 sends “found MIN#1” to RI unit 50;

12.1 RI unit 50 “hangs-up” its connection to the mobility server 40 thereby completing the inter-RI HO;

13.1 Table 13.1 shows the VLR status: the call is now temporarily associated with V-MIN#1 (temporarily maintained on the DCCH-frequency on RI unit 55), MIN#1 is idyll (the mobility server 40 believes MIN#1 is able to take a new call);

Performing An Intra RI HO To Restore Normal VLR Status And Move Call To A Non-DCCH-Frequency

14.1 The target RI unit 55 informs the mobility server 40 that MIN#1 is active with respect to the target RI unit 55;

15.1 Target RI unit 55 communicates a request to the mobility server 40 to set up a conference call including the V-MIN#1, MIN#1, and the third party business phone 21;

16.1 The mobility server 40 responds to the request of step 15.1 by instructing the target RI unit 55 to setup a call to MIN#1 and the target RI unit 55 responds by setting up a call to MIN#1 by finding an available frequency (a non-DCCH-frequency such as a DTC frequency) and time slot to setup the call to MIN#1;

17.1 Target RI unit 55 sends a HO order to MIN#1 to HO to the DTC frequency and time slot of 16.1;

18.1 When the target RI unit 55 detects MIN#1 on the DTC frequency of step 17.1, the target RI unit 55 through-connects the speech path;

19.1 The target RI unit 55 discontinues the old call to V-MIN#1 and hangs-up its connection to the mobility server 40 and thereby completes the inter-RH HO from RI unit 50 to RI unit 55 with MIN#1's call on RI unit 55, see Table 19.1a.

In steps 1.1 and 1.2 of Establishing A Handoff Request, the exchange of DCCH-frequencies involves all the RI units in the DWOS network. Thus, if three RI units were in the DWOS network 20 then the DCCH-frequency of each RI unit would be cross-communicated with the other RI units via the Ethernet.

In step 3.1 above of Establishing A Handoff Request, each DWOS mobile terminal 22 scans neighboring RI units using the DCCH-frequency data shared between the RI units via the Ethernet. In the example here, the mobile terminal 22a is initially in radio cellular communication with the source RI unit 50. Therefore, in step 3.1 above, the mobile terminal 22a is instructed by RI unit 50 to scan the DCCH-frequency being used by the RI unit 55.

It should be understood that while communication between RI units is preferably via an Ethernet connection and the separate communication links between the mobility server and the RI units is preferably via an ISDN connection, any suitable communication link may be used such as copper wire, microwave, fiber optic, or infrared.

While the invention is described above in connection with preferred or illustrative embodiments, these embodiments are not intended to be exhaustive or limiting of the invention. Rather, the invention is intended to cover all alternatives, modifications and equivalents included within its spirit and scope of the invention, as defined by the appended claims.

We claim:

1. In an autonomous private radio communication system, a method for performing a mobile terminal hand-off between two communication control units, comprising:
providing a first communication control unit and a second communication control unit;
connecting a first transceiver to said first communication control unit and a second transceiver to said second communication control unit;
providing radio communication between said first transceiver and a mobile terminal;
handing off said mobile terminal to a select frequency on said second transceiver;
discontinuing said communication between said mobile terminal and said first transceiver unit;
setting up a conference call between said mobile terminal on said selected frequency and a second frequency on said second transceiver unit;
handing off said mobile terminal on said select frequency to said second frequency on said second transceiver thus completing a mobile terminal handoff between said first communication control unit and said second communication control unit.

2. The method of claim 1, wherein said select frequency is a DCCH-frequency.

3. The method of claim 2, wherein said second-frequency is a DTC-frequency.

4. The method of claim 3, wherein handing off said mobile terminal to said selected frequency on said second transceiver is preceded by signal strength measurements between said mobile terminal and said first transceiver, and between said mobile terminal and said second transceiver.

5. The method of claim 3, wherein a virtual mobile terminal is assigned to said second communication control unit.

6. The method of claim 5, wherein said mobile terminal is engaged in a call with a third party phone terminal, said conference call further comprises setting up a conference call with said third party phone terminal and said virtual mobile terminal.

7. The method of claim 6, wherein said mobile terminal is handed off from said DCCH to said DTC-frequency.

8. The method of claim 7, wherein said second terminal is selected from the list consisting of a fixed phone located remote from said autonomous private communication system, a fixed phone located within the area served by said autonomous private communication system, a second mobile terminal located remote from said autonomous private communication system, and a second mobile terminal located within the area served by said autonomous private communication system.

9. The method of claim 8, wherein said first and second transceivers each comprise a transceiver, a scanning receiver and control module, a radio-frequency (RF) transmitter section and an RF receiver section.

10. The method of claim 9, wherein said first and second transceivers each support at least two carriers and at least one scanning uplink receiver.

11. The method of claim 10, wherein said first and second transceivers each support at least at least one DTC and at least one DCCH.

12. An autonomous private communication system comprising:
a first fixed communication interface unit connected to a first transceiver, said first fixed communication interface unit being capable of processing a mobile terminal call via said first transceiver;
a second fixed communication interface unit connected to a second transceiver, said second fixed communication interface unit being capable of processing a mobile terminal call via said second transceiver; and
a connection between said first fixed communication interface unit and said second fixed communication interface unit, where
said first and said second fixed communication interface units include higher-node functionality wherein a call between a mobile terminal and said first transceiver is handed off to said second transceiver using a conference call between said first and second communication units as a vehicle to perform said handoff.

13. The autonomous private communication system of claim 12, wherein said first and second transceivers are radioheads, said radioheads provide radio links for voice and control channels.

14. The autonomous private communication system of claim 12 further comprising a mobility server, wherein said mobility server is connected to said first and said second fixed communication interface units.

15. The autonomous private communication system of claim 14 wherein said autonomous private communication system is a digital wireless office system.

16. In a private autonomous communication system, a communication controller comprising:
an interface for interfacing with a plurality of transceivers; and
a central processing unit (CPU) for implementing a mobile terminal call handoff to another communication controller using a conference call, said CPU being operably coupled to said interface.

17. The communication controller of claim 16 further comprising a second interface for interfacing with at least one other communication controller, said CPU is operably connected to said second interface.

18. The communication controller of claim 17, wherein said plurality of transceivers comprises a plurality of radioheads, said plurality of radioheads provides radio links for voice and control channels.

19. The communication controller of claim 18 further comprising a line connection to at least one other communication controller.

20. The communication controller of claim 19, further comprising a connection to a mobility server.
